(19) United States
(12) Patent Application Publication
(10) Pub. No.: US 2022/0072974 A1
(43) Pub. Date: Mar. 10, 2022

(54) SYSTEM AND METHOD FOR EXCHANGING A BATTERY OF A VEHICLE

(71) Applicant: ZF FRIEDRICHSHAFEN AG, Friedrichshafen (DE)

(72) Inventor: Xuting Huang, Altdorf (DE)

(73) Assignee: ZF FRIEDRICHSHAFEN AG, Friedrichshafen (DE)

(21) Appl. No.: 17/012,975

(22) Filed: Sep. 4, 2020

(51) Int. Cl. B60L 53/80; G06F 21/44; G06F 16/27

(52) U.S. Cl. CPC B60L 53/80; G06F 16/27; G06F 21/44

(57) ABSTRACT

A method is provided for exchanging a battery of an electric vehicle. The method comprises receiving a request to exchange a first battery of an electric vehicle, the request including a battery identification code associated with the first battery. The method further comprises obtaining an initial location of the electric vehicle and selecting a mobile battery exchange device based on the battery identification code. The method further comprises determining a meeting point based on the initial location of the electric vehicle and a current location of the selected mobile battery exchange device. Additionally, the method comprises authenticating the electric vehicle to enter a battery exchange compartment of the mobile battery exchange device. The method further comprises exchanging the first battery of the electric vehicle for a second battery pre-stored in the battery exchange compartment.

### TECHNICAL FIELD

This application generally relates to electrification of vehicles. In particular, this application describes a system and method for exchanging a battery of an electric vehicle.

### BACKGROUND

Along with electrification and intellectualization of the vehicles, the complexity of vehicular services with regard to battery management demanded by potential customers grows drastically. While efforts have been made to increase the energy density stored in battery cells, it remains a major challenge to overcome the difficulties arising with recharging the batteries. On the one hand, electricity providers are facing the question increasingly how to fulfill the power demands when the number of electric vehicles rises. On the other hand, traffic planers in major cities are trying to tackle the problem that the number of charge stations are limited.

Hence, there is a large demand for solutions which can overcome the above-mentioned problems associated with the overall electromobility infrastructure.

### SUMMARY

A method is provided for exchanging a battery of an electric vehicle. The method comprises receiving a request to exchange a first battery of an electric vehicle, the request including a battery identification code associated with the first battery. The method further comprises obtaining an initial location of the electric vehicle and selecting a mobile battery exchange device based on the battery identification code. The method further comprises determining a meeting point based on the initial location of the electric vehicle and a current location of the selected mobile battery exchange device. Additionally, the method comprises authenticating the electric vehicle to enter a battery exchange compartment of the mobile battery exchange device. The method further comprises exchanging the first battery of the electric vehicle for a second battery pre-stored in the battery exchange compartment.

### BRIEF DESCRIPTION OF THE DRAWINGS

FIG. 1 illustrates an exemplary environment that facilitates changing a vehicular service preference;

FIG. 2 illustrates an exemplary schematic diagram of various hardware components that may be included in one or more terminals of the environment to facilitate interactions with a decentralized database;

FIG. 3 illustrates exemplary operations that may be implemented by a terminal;

FIG. 4 illustrates further exemplary operations that may be implemented by a terminal;

FIG. 5 illustrates further exemplary operations that may be implemented by a terminal;

FIG. 6 illustrates further exemplary operations that may be implemented by a terminal;

FIG. 7 illustrates further exemplary operations that may be implemented by a terminal; and

FIG. 8 illustrates an exemplary computer system that may form part of or implement the terminals described in the figures or in the following paragraphs.

### DETAILED DESCRIPTION

The embodiments described below overcome the problems discussed above by providing a system and a method which enable to exchange batteries for electric vehicles in a manner that minimizes the need to transform or upgrade the infrastructure such as roads and charging stations. Electric vehicles carrying a battery which needs to be recharged may issue a corresponding request. A mobile battery exchange device which in various embodiments comprises a vehicle (e.g., a truck) with a compartment for loading an electric vehicle as well as at least one pre-stored battery is selected, based on the battery's identification code, by the system that carries out the method.

Then, a meeting point at which the electric vehicle and the mobile battery exchange device can meet each other is determined based on the initial location of the electric vehicle and a current location of the selected mobile battery exchange device. The electric vehicle and the mobile battery exchange device will then be guided to the determined meeting point. This enables to minimize the duration of travel until both vehicles join together, so that the battery of the electric vehicle is less consumed.

Then, the electric vehicle is authenticated to enter a battery exchange compartment of the mobile battery exchange device, so that the first battery of the electric vehicle can be exchanged for a second battery pre-stored in the battery exchange compartment. This ensures that the electric vehicle is brought into connection with the correct mobile battery exchange device and vice versa. Therefore, this reduces the likelihood of erronoues battery exchanges and installations.

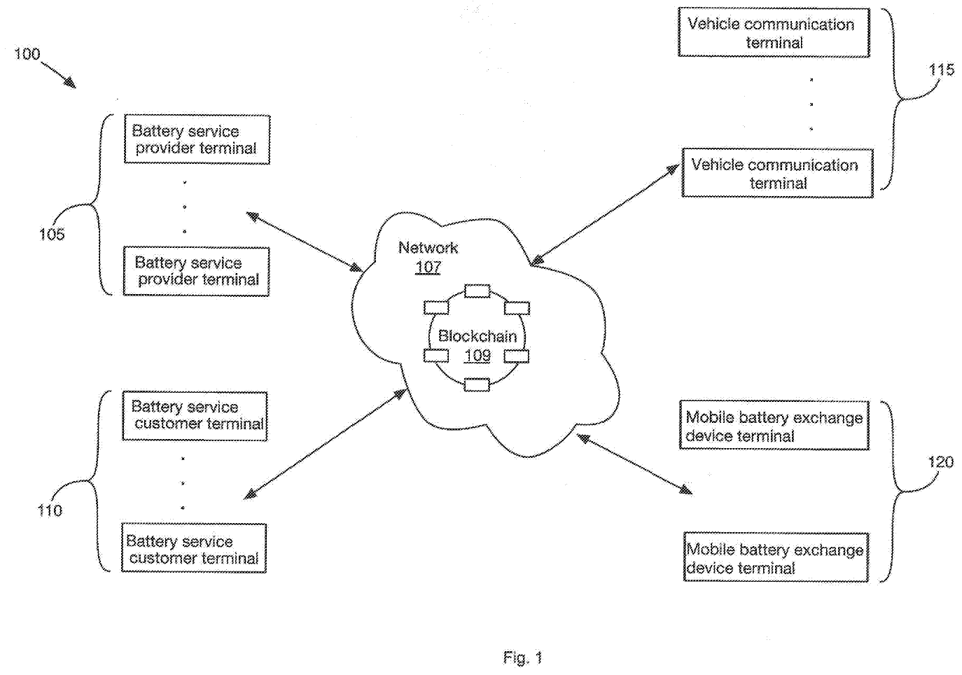

FIG. 1 illustrates an exemplary environment 100 that facilitates exchanging batteries for electric vehicles in an efficient and secure manner. Illustrated in the environment 100 are entities that include one or more battery service provider terminals 105, one or more battery service customer terminals 110, one or more vehicle communication terminals 115, and one or more mobile battery exchange device terminals 120.

The battery service provider terminals 105 may be servers or computer systems operated by companies involved directly in the battery sector such as battery management companies and battery producers, or automotive companies including OEMs, component suppliers (e.g., tier 1 suppliers) and providers of mobility services such as car sharing, car renting, car infotainment services, car hailing and the like. Within the scope of the present invention, such entities are regarded as battery service providers which the battery service provider terminals 105 are associated with.

The battery service customer terminals 110 may correspond to computer systems or devices (e.g., mobile devices) of customers of the battery service providers (battery service customers). The computer systems or mobile devices may operate one or more application softwares (Apps) to assist the battery service customers in requesting services from the battery service providers. The battery service customers may be registered in a database of the battery service providers that links registered customers (including their contact information) to individual battery services. More than one battery service customer may be registered to a particular battery service in various embodiments.

The vehicle communication terminals 115 may correspond to computer systems of vehicles including a data interface for data exchange. The vehicles may be operated by end users or fleet provider companies. That is, the vehicle may be operated by end users being individuals, or companies that operate a fleet of vehicles (e.g. companies which provide mobility as a service). The vehicle communication terminals 115 may comprise a control-area-network (CAN), in particular a CAN Bus, and/or a wireless network, in particular a nearfield communication (NFC) network based on infrared (IR) or Bluetooth.

The mobile battery exchange device terminals 120 may correspond to computer systems of mobile battery exchange devices including a data interface for data exchange. The mobile battery exchange devices are special vehicles comprising a compartment for storing at least one battery and for performing battery exchange at a vehicle. The mobile battery exchange devices may be operated by the battery service providers as mentioned above. In the alternative, the mobile battery exchange devices may be operated by entities other than the battery service providers but in cooperation with the latter. The mobile battery exchange devices terminals 120 may comprise a control-area-network (CAN), in particular a CAN Bus, and/or a wireless network, in particular a nearfield communication (NFC) network based on infrared (IR) or Bluetooth.

As described in more detail below, one or more of the terminals (105, 110, 115 and 120) may include various hardware components that facilitate interactions and communications with one another, for example, via a wired or wireless network 107 (e.g., the Internet). In certain examples, the battery service provider terminals 105 comprise servers or computer systems, which may communicate with one or more of the battery service customer terminals 110 (e.g., servers or devices), the vehicle communication terminals 115 (e.g., vehicle computer systems), and/or the mobile battery exchange device terminals 120 (e.g., vehicle computer systems), and vice versa. Further, one or more of the terminals (105, 110, 115, and 120) may include an ability to interact with a decentralized database 109 of the network 107 such as a blockchain decentralized database.

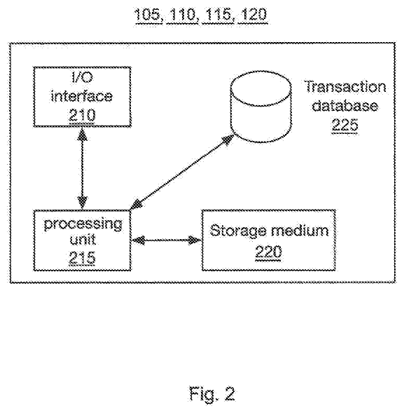

FIG. 2 illustrates an exemplary schematic diagram of various hardware components that may be included in the terminals (105, 110, 115, and 120) to facilitate interactions with other terminals and/or the decentralized database 109. Referring to the diagrams, each terminal may include a processing unit 215 such as a central processing unit (CPU), an input/output (I/O) interface 210, and a storage medium 220.

The I/O interface 210 of each terminal (105, 110, 115, and 120) facilitates communications with other terminals (105, 110, 115, and 120) of the environment 100. In this regard, the I/O interface 210 may implement an API such as a SOAP-based web services API to facilitate communicating information to the other terminals (105, 110, 115, and 120). Other APIs, such as a RESTful API, may be implemented to facilitate communications between terminals (105, 110, 115, and 120). Additionally, the terminals (105, 110, 115, and 120) may implement other traditional forms of communication with other terminals (105, 110, 115, and 120), such as email messages, text or SMS messages, and/or phone calls. For example, the battery service provider terminal 105 may be able to communicate with the battery service customer terminal 110, the vehicle communication terminal 115, and the mobile battery exchange device terminal 120 via any of these known communication mediums. Additionally, in other examples, the battery service customer terminal 110, the vehicle communication terminal 115, and/or the mobile battery exchange device terminal 120 may execute and implement certain applications, for example, proprietary applications of the battery service providers such as OEMs, component suppliers or mobility service providers. The battery service customer terminal 110 may be able to send messages via such proprietary applications to the battery service provider terminal 105 and/or the mobile battery exchange device terminal 120 and vice versa.

The I/O interface 210 of each terminal may be configured to dynamically determine the communication methodology utilized by other terminals (105, 110, 115, and 120) of the environment 100 and to communicate information to the other terminals (105, 110, 115, and 120) using the determined communication methodology. For example, the I/O interface 210 may determine that a first terminal utilizes a RESTful API and may, therefore, communicate with the terminal using a RESTful communication methodology.

The I/O interface 210 may implement a web browser to facilitate generating one or more web-based interfaces or screenshots that facilitate user interactions with the respective terminals (105, 110, 115, and 120). In this regard, web services may be implemented to facilitate automating some of the web-based functionality via a computer. For example, the battery service provider terminal 105, which may comprise one or more servers, may provide such web-based interfaces that facilitate user interactions through the battery service customer terminal 110 and/or the vehicular communication terminal 115.

The CPU 225 executes instruction code stored in a storage medium 220 for coordinating activities performed between the various subsystems. The CPU 225 may correspond to an Intel®, AMD®, ARM® based CPU or a different CPU. The CPU may perform instructions according to an operating system such as Linux or a different operating system.

In various embodiments, one or more of the terminals (105, 110, 115, and 120) may include a transaction database 225. The transaction database 225 is configured to hold records about possible business transactions between the different parties the terminals (105, 110, 115, and 120) are associated with. In particular, a battery identification code associated with the first battery, a vehicle identification code associated with the electric vehicle, one or more pieces of authentication information used for authenticating electric vehicle in order to enter the battery exchange compartment of the mobile battery exchange device can be held in the transaction database 225 of the terminals (105, 110, 115, and 120).

In various embodiments, records in the storage medium 220 and the transaction database 225 of each terminal may be replicated with one another and collectively form a decentralized database that may correspond to a block-chain database 109. In this regard, the block-chain database 109 may be utilized as a way to construct consensus around the validity of transactions, and to ensure that all changes are auditable. Stated differently, the blockchain database corresponds to a record of consensus with a cryptographic audit trail that is maintained and validated by each system. Block chains of the block-chain database act as a way to record the order of, and validate the transactions in, the block-chain database. As will be described below, the block chains further facilitate value transfer between the parties—without the usual requirement for a trusted third party. Moreover, such a database facilitates the implementation of smart contracts (e.g. for business rules) that automate processes on such a database (e.g. for defining & delivering incentives to different parties in the supply chain).

It is contemplated that any of the systems described above and/or any subsystem thereof may correspond to a stand-alone computer system such as an Intel®, AMD®, or PowerPC® based computer system or a different computer system and can include application specific computer systems. The computer systems may include an operating system, such as Microsoft Windows®, Linux, Unix® or other operating system. It is also contemplated that operations performed on the various subsystems may be combined into a fewer or greater number of subsystems to facilitate speed scaling, cost reductions, etc.

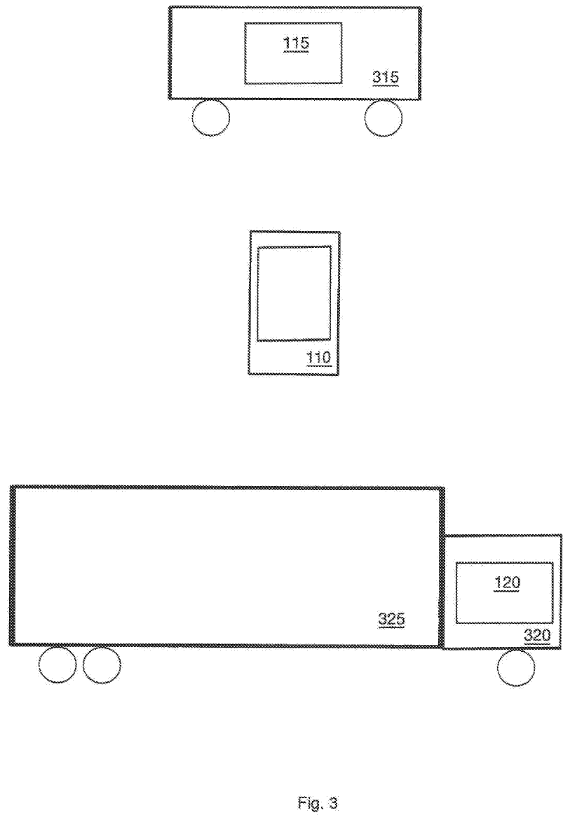

FIG. 3 illustrates examples for the entities with which the terminals 110, 115, 120 are associated with. The battery service customer terminal 110 is exemplarily shown as a mobile device, such as a smartphone, whose user/owner is the battery service customer the battery service customer terminal 110 is associated with. The vehicle communication terminal 115 is exemplarily shown as computer system of an electric vehicle 315 (e.g., a passenger car) which is owned/used by the battery service customer. The mobile battery exchange device terminal 120 is exemplarily shown as computer system of a truck 320 comprising a compartment 325 for performing the exchange of batteries.

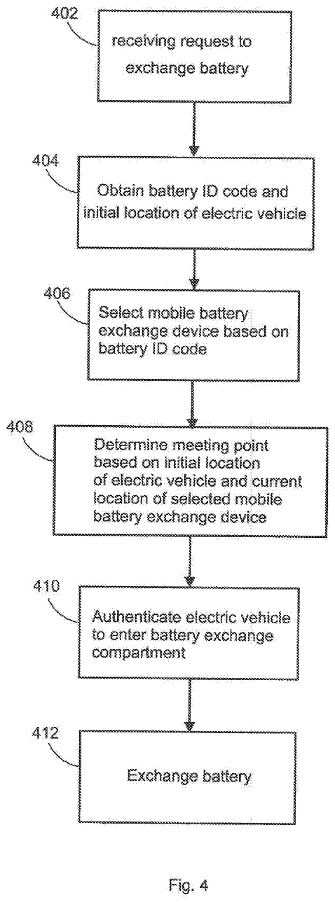

FIG. 4 illustrates exemplary operations that may be performed by the system, and in a particular example, at least partially by the battery service provider terminals 105, e.g., battery service provider server such as OEM servers, component supplier servers or mobility service provider servers. In various embodiments, at 402, the battery service provider terminal 105 receives a request to exchange a first battery of the electric vehicle 315. The request may be transmitted by the battery service customer terminal 110 or the vehicle communication terminal 115. In the cases where the request is transmitted by the battery service customer terminal 110, the battery service customer terminal 110 may first receive a notification from the vehicle communication terminal 115 indicating that the electric vehicle 315 is running out of battery. The notification can be presented as a graphic signal, an audio signal and/or a vibrational signal. The battery service customer may then send the request to exchange battery e.g., using an application software (App) in conjunction with a Human-Machine-Interface (HMI) installed on the battery service customer terminal 110 being a mobile device such as smartphone. Upon receiving of the request, at 404, a battery identification (ID) code associated with the first battery currently installed in the electric vehicle 315 and an initial location of the electric vehicle 315 are obtained. The corresponding data can be transmitted by the vehicle communication terminal 115 directly or via the battery service customer terminal 110 to the battery service provider terminal 105. Based on the obtained battery ID code, a mobile battery exchange device such as a truck 320 with a battery exchange compartment 325 first selected. In various embodiments, the mobile battery exchange device is selected from a database where data of a plurality of mobile battery exchange devices are stored. The data may include the type of battery currently stored or can be stored in the battery exchange compartment 325 of the truck 320, the maximum allowable speed of the truck and/or customer feedbacks about the truck 320. The selection of the mobile battery exchange device may be performed directly by the battery service provider terminal 105, or based on an approval/selection of the battery service customer performed at the battery service customer terminal 110.

Upon selection of the mobile battery exchange device, at 408, a meeting point for the electric vehicle 315 and the mobile battery exchange device 320 to meet each other is determined based on the initial location of the electric vehicle 315 and a current location of the selected mobile battery exchange device 320. This may be performed directly by the battery service provider terminal 105. In various embodiments, the battery service provider terminal 105 may retrieve a database such as a look-up-table (LUT) to find out the current location of the selected mobile battery exchange device 320. In the alternative, the mobile battery exchange device terminal 120 associated with the selected mobile battery exchange device 320 may transmit the current location of the selected mobile battery exchange device 320 upon request of the battery service provider terminal 105 and/or the battery service customer terminal 110. The determination of the meeting point may further take into account a pre-defined destination of the electric vehicle 315, the average and/or maximum allowable speed of the electric vehicle 315 and the selected mobile battery exchange device 320, the traffic density of relevant streets/areas and/or the time. The battery service provider terminal 105 may transmit a suggested meeting point to the battery service customer terminal 110 for approval. If the suggested meeting point is not approved by the battery service customer, another suggestion of the meeting point is transmitted by the battery service provider terminal 105 to the battery service customer terminal 110. In the alternative, the battery service provider terminal 105 may transmit a plurality of suggested meeting points to the service customer terminal 110 at once so that the latter may select one of them to be the final meeting point.

Then, the electric vehicle 315 and the selected mobile battery exchange device 320 travel to the determined meeting point. In various embodiments, the electric vehicle 315 and/or the mobile battery exchange device 320 may use a navigation system (e.g., the global navigation satellite system, GNSS) to navigate itself towards the meeting point. Alternatively or additionally, the navigation may be fully performed or assisted by a sensor-based system such as using a camera, radar and/or lidar which captures the surrounding of the respective vehicle. The captured data may be processed by a computer system of the respective vehicle (e.g. the vehicle communication terminal 115 or the mobile battery exchange device terminal 120) or the battery service provider terminal 105. In particular, the processing unit 215 of the various terminals 105, 115, 120 may performed the data processing based on one or more algorithms, e.g. neural networks. In the alternative, the captured data may be processed by a processing unit including one or more algorithms, e.g., neural networks, installed in the decentralized database 109.

During travel of the respective vehicles 315, 320, the meeting point determined may need to be changed/adjusted due to an event (e.g., a car accident, a fire breaking out and a related fire-fighting-operation) occurring or becoming relevant in the mean time. In various embodiments, the battery service provider terminal 105 may determine one or more new meeting points based on receiving information relating to such events and transmit it/them to the battery service customer terminal 110 for approval/selection, analogously to the above-mentioned operations.

The current location of the selected mobile battery exchange device 320 may be tracked, e.g., based on data provided by the navigation system such as GNSS or data captured by the sensor-based system. The tracking result may be presented on the HMI of the battery service customer terminal 110. In this way, the battery service customer is informed about the current location of the selected mobile battery exchange device 320 in realtime.

Once the electric vehicle 315 and the selected mobile battery exchange device 320 are at the meeting point, at 410, the electric vehicle 315 is authenticated in order to enter the battery exchange compartment 325 of the mobile battery exchange device/truck 320. This may be based on exchanging encrypted data between the electric vehicle 315 and the mobile battery exchange device 320. In various embodiments, the battery service provider terminal 105 may transmit a encrypted data (e.g., a QR code, a barcode, a number and/or a string) to the battery service customer terminal 110 and/or the vehicle communication terminal 115 of the electric vehicle 315. Also, the battery service provider terminal 105 may transmit a corresponding dataset to the mobile battery exchange terminal 120 of the selected mobile battery exchange device 320. The corresponding dataset contains a decryption key enabling to decrypt the encrypted data. The corresponding dataset further contains verification data, which can be compared with the encryption data once decrypted. In various embodiments, the HMI of the battery service customer terminal 110 being a mobile device may display the QR code//barcode received from the battery service provider terminal 105. A scanning unit of the mobile battery exchange device 320, which is in communication with the mobile battery exchange device terminal 120, may scan the QR code/barcode and transmit the scanned code to the mobile battery exchange device terminal 120. The processing unit 215 of the mobile battery exchange device terminal 120 may decrypt the scanned QR code/barcode and decrypt it using the decryption key received from the battery service provider terminal 105 and compare the decrypted QR code/barcode with the verification data received from the battery service provider terminal 105. The verification data, the decryption key and/or the encryption data may be issued with a limited time within which it is active. After the lapse of the limited time, the battery service provider terminal 105 may transmit the respective data/key again, preferably upon request by the battery service customer terminal 110.

Once matching between the decrypted QR code/barcode and the verification data is found, the mobile battery exchange terminal 120 may generate a control signal to open the compartment 325. The exchange of the battery takes place, at 412. This may be performed using a robotic system comprising one or more robotic arms controlled by the mobile battery exchange device terminal 120, with or without human intervention. As an optional measure, the surface of the first battery may first be cleaned, e.g., using the robotic system, before the first battery is detached from the electric vehicle 315. This facilitates to expose fixing means such as screws with which the first battery is fixed to a battery cell frame of the electric vehicle 315 since objects covering the surface of the battery cell such as dirt and mud are removed in this manner. Thus, the robotic system can easily and securely detach the first battery. After the first battery has been exchanged with a second battery pre-stored in the battery exchange compartment 325, the mobile battery exchange terminal 120 may generate a control signal again to open the compartment 325.

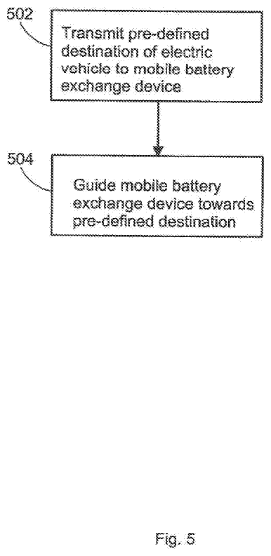

FIG. 5 illustrates exemplary operations that may be performed by the system, and in a particular example, at least partially by the battery service provider terminals 105, e.g., battery service provider server such as OEM servers, component supplier servers or mobility service provider servers. In various embodiments, the electric vehicle 315 may need to arrive in a pre-defined destination as soon as possible or before a certain time point. In such cases, it is advantageous to continue travelling towards the pre-defined destination despite the need to exchange battery. After the exchange of battery has begun, at 502, the pre-defined destination of the electric vehicle 315 is transmitted from the vehicle communication terminal 115 of the electric vehicle 315 to the mobile battery exchange device terminal 120 of the selected mobile battery exchange device 320. Based on the transmitted pre-defined destination, at 504, the mobile battery exchange device 320 may be guided towards the pre-defined destination during the process of battery exchange.

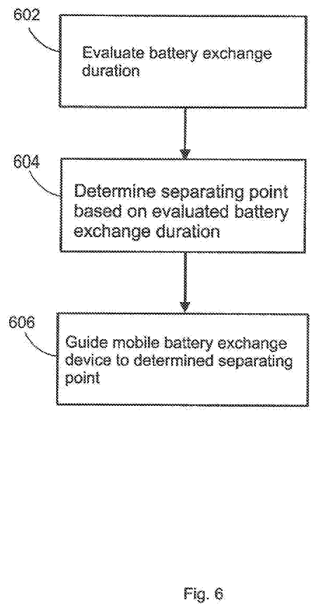

FIG. 6 illustrates exemplary operations that may be performed by the system, and in a particular example, at least partially by the battery service provider terminals 105, e.g., battery service provider server such as OEM servers, component supplier servers or mobility service provider servers. In various embodiments, the user of the electric vehicle 315 (which may be the same person as the battery service customer or a different person) may need to know where the electric vehicle 315 can be separated from the mobile battery exchange device 320 after completion of the battery exchange process. Before the battery exchange has begun or during the battery exchange process, at 602, a battery exchange duration may be evaluated. This can be performed by the processing unit 215 of one of the terminals 105, 110, 115, 120. In a particular example, this is performed by the battery service provider terminal 105. Then, at 604, a separating point, which is a location for the electric vehicle 315 to be separated from the mobile battery exchange device 320 after completion of the battery exchange process, is determined based on the evaluated battery exchange duration. The determination of the separating point preferably also takes into account the average and/or maximum allowable speed of the mobile battery exchange device 320. In various embodiments, the determined separating point can be transmitted to an authenticated third party via the network 107. As an optional measure, at 606, the mobile battery exchange device 320 can be guided to the determined separating point, e.g., using a navigation unit in communication with the mobile battery exchange device terminal 120.

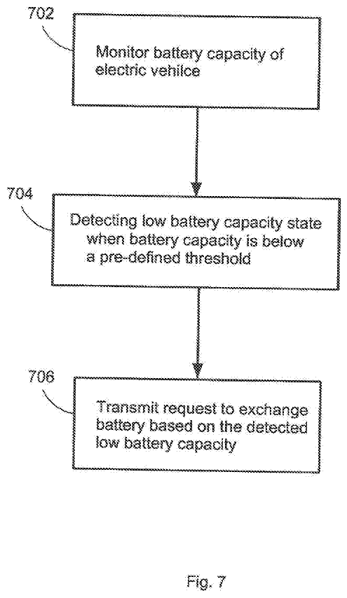

FIG. 7 illustrates exemplary operations that may be performed by the system, and in a particular example, at least partially by the battery service provider terminals 105, e.g., battery service provider server such as OEM servers, component supplier servers or mobility service provider servers. In various embodiments, the user of the electric vehicle 315 (which may be the same person as the battery service customer or a different person) may need to request to exchange battery at a sufficiently early time point. At 702, a battery capacity of the first battery mounted in the electric vehicle 315 may be monitored continuously or periodically. This can be performed by a battery capacity monitoring unit in communication with the vehicle communication terminal 115 of the electric vehicle 315. Then, at 704, a low battery capacity state is detected when the monitored battery capacity is below a pre-defined threshold. In various embodiments, the detected a low battery capacity state can be transmitted from the vehicle communication terminal 115 to the battery service customer terminal 110. At 706, the battery service customer can then send the request to exchange battery to the battery service provider as described at 402 of FIG. 4.

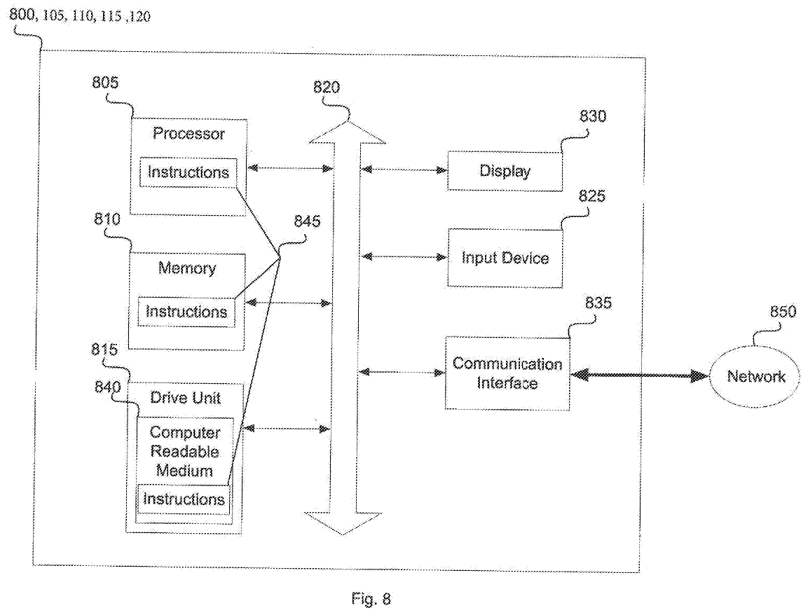

FIG. 8 illustrates a computer system 800 that may form part of or implement the terminals (105, 110, 115 and/or 120) described above. The computer system 800 may include a set of instructions 845 that the processor 805 may execute to cause the computer system 800 to perform any of the operations or methods described above. The computer system 800 may operate as a stand-alone device or may be connected, e.g., using a network, to other computer systems or peripheral devices.

In a networked deployment, the computer system 800 may operate in the capacity of a server or as a client-user computer in a server-client user network environment, or as a peer computer system in a peer-to-peer (or distributed) network environment. The computer system 800 may also be implemented as or incorporated into various devices, such as a personal computer or a mobile device, capable of executing the instructions 845 (sequential or otherwise) that specify actions to be taken by that machine. Further, each of the systems described may include any collection of sub-systems that individually or jointly execute a set, or multiple sets, of instructions to perform one or more computer functions.

The computer system 800 may include one or more memory devices 810 on a bus 820 for communicating information. In addition, code or instructions operable to cause the computer system to perform any of the operations and/or methods described above may be stored in the memory 810. The memory 810 may be a random-access memory, read-only memory, programmable memory, hard disk drive or any other type of memory or storage device.

The computer system 800 may include a display 830, such as a liquid crystal display (LCD), a cathode ray tube (CRT), or any other display suitable for conveying information. The display 830 may act as an interface, in particular a Human Machine Interface (HMI), for the user to see the functioning of the processor 805, or specifically as an interface with the software stored in the memory 810 or in the drive unit 815.

Additionally, the computer system 800 may include an input device 825, such as a keyboard or mouse, configured to allow a user to interact with any of the components of system 800. Additionally, the input device 825 may comprise a scanner, such as a camera, an optical sensor, a laser, a RFID reader, or any other device capable of scanning and/or sensing an identifying mark or signal on a replacement part.

The computer system 800 may also include a disk or optical drive unit 815. The disk drive unit 815 may include a computer-readable medium 840 in which the instructions 845 may be stored. The instructions 845 may reside completely, or at least partially, within the memory 810 and/or within the processor 805 during execution by the computer system 800. The instructions 845, when executed by the processor 805, may cause the processor 805 to perform any of the operations and/or methods discussed herein. The memory 810 and the processor 805 also may include computer-readable media as discussed above.

The computer system 800 may include a communication interface 835 to support communications via a network 850. The network 850 may include wired networks, wireless networks, or combinations thereof. The communication interface 835 network may enable communications via any number of communication standards, such as 802.11, 802.12, 802.20, WiMAX, cellular telephone standards, Bluetooth, or other communication standards.

Accordingly, the method and system may be realized in hardware, software, or a combination of hardware and software. The method and system may be realized in a centralized fashion in at least one computer system or in a distributed fashion where different elements are spread across several interconnected computer systems. Any kind of computer system or other apparatus adapted for carrying out the methods described herein may be employed.

The method and system may also be embedded in a non-transitory computer program product, which includes all the features enabling the implementation of the operations described herein and which, when loaded in a computer system, is able to carry out these operations. Computer program in the present context means any expression, in any language, code or notation, of a set of instructions intended to cause a system having an information processing capability to perform a particular function, either directly or after either or both of the following: a) conversion to another language, code or notation; b) reproduction in a different material form.

While methods and systems have been described with reference to certain embodiments, it will be understood by those skilled in the art that various changes may be made, and equivalents may be substituted without departing from the scope of the claims. Many other modifications may be made to adapt a particular situation or material to the teachings without departing from its scope. Therefore, it is intended that the present methods and systems not be limited to the particular embodiment disclosed, but that the disclosed methods and systems include all embodiments falling within the scope of the appended claims.

What is claimed is:

1. A method for exchanging a battery of an electric vehicle, the method comprising the steps of:
receiving a request to exchange a first battery of an electric vehicle;
obtaining a battery identification code associated with the first battery, and an initial location of the electric vehicle;
selecting a mobile battery exchange device based on the battery identification code;
determining a meeting point based on the initial location of the electric vehicle and a current location of the selected mobile battery exchange device;
authenticating the electric vehicle to enter a battery exchange compartment of the mobile battery exchange device; and
exchanging the first battery of the electric vehicle for a second battery pre-stored in the battery exchange compartment.

2. The method of claim 1, wherein the mobile battery exchange device is selected further based on the initial location of the electric vehicle.

3. The method of claim 1, further comprising the steps of:
obtaining a vehicle identification code associated with the electric vehicle;
selecting the mobile battery exchange device further based on the vehicle identification code.

4. The method of the claim 1, wherein:
the request to exchange the first battery is communicated via a decentralized database; and/or
the authentication of the electric vehicle is performed based on communicating via the decentralized database.

5. The method of claim 1, further comprising the step of:
transmitting a pre-defined destination of the electric vehicle to the mobile battery exchange device.

6. The method of claim 5, further comprising the step of:
guiding the mobile battery exchange device towards the pre-defined destination of the electric vehicle during exchanging of the battery.

7. The method of claim 1, further comprising the step of:
charging the first battery after the latter has been detached from the electric vehicle.

8. The method of claim 1, further comprising the step of:
cleaning a surface of the first battery before detaching the first battery from the electric vehicle.

9. The method of claim 1, wherein:
the exchanging of the first battery with the second battery is performed using a robotic system installed in the mobile battery exchange device.

10. The method of claim 1, further comprising the steps of:
evaluating a battery exchange duration;
determining a separating point based on the evaluated battery exchange duration;
guiding the mobile battery exchange device to the separating point.

11. The method of claim 1, further comprising the steps of:
monitoring a battery capacity of the first battery of the electric vehicle;
detecting a low battery condition of the first battery when the battery capacity is below a pre-defined threshold;
transmitting the request to exchange the first battery of the electric vehicle automatically based on the detected low battery condition.

12. A method for exchanging a battery of an electric vehicle comprising the steps of:
receiving a request to exchange a first battery of an electric vehicle;
obtaining a battery identification code associated with the first battery, and an initial location of the electric vehicle;
selecting a mobile battery exchange device based on the battery identification code;
determining a meeting point based on the initial location of the electric vehicle and a current location of the selected mobile battery exchange device;
authenticating the electric vehicle to enter a battery exchange compartment of the mobile battery exchange device; and
exchanging the first battery of the electric vehicle for a second battery pre-stored in the battery exchange compartment;
wherein a processor, which is in communication with the instruction code storage, performs the steps and an instruction code storage unit stores instructions which are implemented by the processor.
